(19) United States
(12) Patent Application Publication
(10) Pub. No.: US 2025/0216988 A1
(43) Pub. Date: Jul. 3, 2025

(54) ELECTRONIC DEVICE AND METHOD FOR CONTROLLING TOUCH INPUT

(71) Applicant: SAMSUNG ELECTRONICS CO., LTD., Suwon-si (KR)

(72) Inventors: Jonghwa LEE, Suwon-si (KR); Suyong KIM, Suwon-si (KR)

(21) Appl. No.: 19/087,150

(22) Filed: Mar. 21, 2025

Related U.S. Application Data
(63) Continuation of application No. PCT/KR2023/012826, filed on Aug. 29, 2023.

(30) Foreign Application Priority Data
Sep. 22, 2022 (KR) 10-2022-0120367
Oct. 12, 2022 (KR) 10-2022-0130943

(51) Int. Cl. G06F 3/041; G06F 3/0484; G06F 3/0488

(52) U.S. Cl. CPC G06F 3/04186; G06F 3/0484; G06F 3/0488; G06F 2203/04803

(57) ABSTRACT

An electronic device according to one embodiment is provided. The electronic device includes a display and at least one processor. The at least one processor includes settings configured by means of a touch screen driver, displays a plurality of windows through the display, activates a first window from among the plurality of windows and sets same as an active window, and, while the first window is active, sets the touch screen driver such that recognition of a touch input in regions other than the first window region is denied.

### CROSS-REFERENCE TO RELATED APPLICATIONS

This application is a by-pass continuation application of International Application No. PCT/KR2023/012826, filed on Aug. 29, 2023, which is based on and claims priority to Korean Patent Application No. 10-2022-0130943, filed on Oct. 12, 2022, and Korean Patent Application No. 10-2022-0120367, filed on Sep. 22, 2022, in the Korean Intellectual Property Office, the disclosures of which are incorporated by reference herein their entireties.

### BACKGROUND

The following descriptions relate to an electronic device and a method for controlling a touch input.

An electronic device may receive a touch input. The electronic device may refrain from performing a designated touch input in order to prevent an operation by an unintended touch input from being performed. In order to refrain from recognizing the designated touch input, the electronic device may filter out the received touch inputs.

The above-described information may be provided as a related art for the purpose of helping to understand the present disclosure. No claim or determination is raised as to whether any of the above-described information may be applied as a prior art related to the present disclosure.

### SUMMARY

According to an embodiment, an electronic device may include a display and at least one processor. The electronic device may include the display. The electronic device may include the at least one processor. The display may include a display panel and a touch screen panel. The display may include the touch screen panel. The display may include a touch screen panel. The at least one processor may include a setting configured by a touch screen driver. The at least one processor may display a plurality of windows through the display. The at least one processor may set a first window as an active window by activating the first window among the plurality of windows. The at least one processor may, while the first window is activated, set the touch screen driver to refrain from recognizing a touch input in another area different from an area of the first window. The at least one processor may, while the first window is activated, perform a function corresponding to a first user input based on receiving the first user input within the area of the first window. The at least one processor may, while the first window is activated, perform a function corresponding to a second user input that is not a touch input based on receiving, in the another area different from the area of the first window, the second user input that is not the touch input.

According to an embodiment, a method performed by an electronic device may include displaying a plurality of windows through a display. The method may include setting a first window as an active window by activating the first window among the plurality of windows. The method may include, while the first window is activated, setting a touch screen driver to refrain from recognizing a touch input in another area different from an area of the first window. The method may include, while the first window is activated, performing a function corresponding to a first user input based on receiving the first user input within the area of the first window. The method may include, while the first window is activated, performing a function corresponding to a second user input that is not a touch input based on receiving, in the another area different from the area of the first window, the second user input that is not the touch input.

### BRIEF DESCRIPTION OF THE DRAWINGS

FIG. 1 is a block diagram of an electronic device in a network environment according to various embodiments.

FIG. 2 is a block diagram of a display module of an electronic device according to various embodiments of the present disclosure.

FIG. 3 is an example of an electronic device for receiving a user input.

FIG. 4A is an example of a cross-section of a display including a touch screen and a digitizer.

FIG. 4B is an example of a cross-section of a display for receiving a touch input and a pen input.

FIG. 5 is an example of an electronic device for filtering out a touch input.

FIG. 6 is a flow of an operation of an electronic device for filtering out a user input.

FIG. 7 is a flow of an operation of an electronic device for identifying an activated first window.

FIG. 8 is a flow of an operation of an electronic device for identifying an active window area.

### DETAILED DESCRIPTION

Terms used in the present disclosure are used only to describe a specific embodiment, and may not be intended to limit scope of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since various embodiments of the present disclosure include technology that uses both hardware and software, the various embodiments of the present disclosure do not exclude a software-based approach.

A term referring to a user input (e.g., the user input, an input), a term referring to an active area (e.g., the active area, an active region, an activated area, an activated region, and a filtering exclusion area), and the like that used in the following description are exemplified for convenience of explanation. Therefore, the present disclosure is not limited to terms described below, and other terms having equivalent technical meanings may be used. In addition, terms ‘ . . . unit,’ ‘ . . . device,’ ‘ . . . object,’ and ‘ . . . structure’, and the like, used below may mean at least one shape structure or a unit that processes a function.

In addition, in the present disclosure, a term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ means at least one of elements from A (including A) to B (including B). Hereinafter, ‘C’ and/or ‘D’ means that at least one of ‘C’ or ‘D’, that is, {′C′, ‘D’, ‘C’ and ‘D’}.

Prior to describing embodiments of the present disclosure, the terms necessary to describe operations of an electronic device according to embodiments are defined. A filter driver means the software capable of modifying, editing, and filtering out information received from the hardware. The active window area means a portion occupied by an active window on a display. An application programming interface (API) means a language or a message format used for communication between an operating system and an application program.

Hereinafter, various embodiments disclosed in the present document will be described with reference to an attached drawing. For convenience of explanation, components illustrated in the drawing may be exaggerated or reduced in their sizes, and the present invention is not necessarily limited thereto as the illustrated.

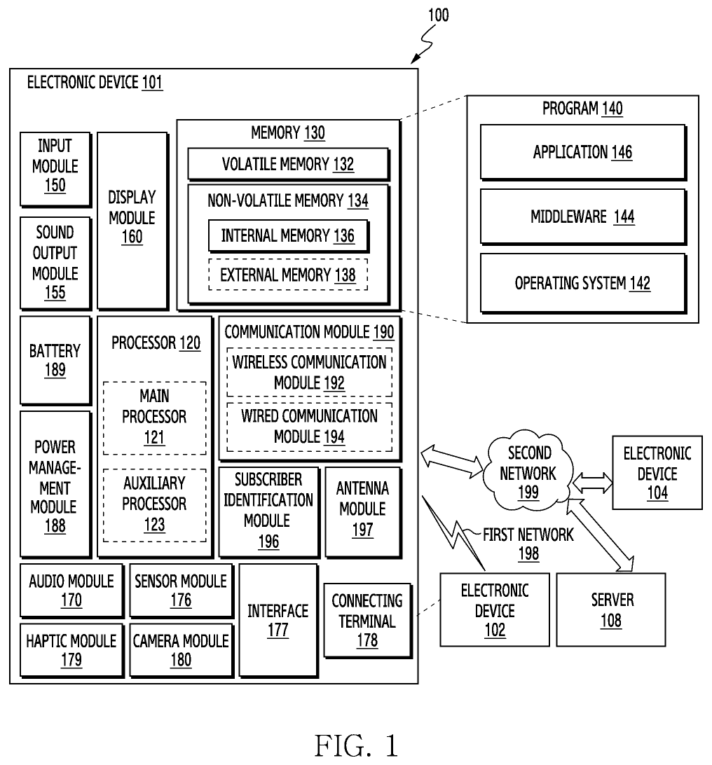

FIG. 1 is a block diagram of an electronic device in a network environment according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

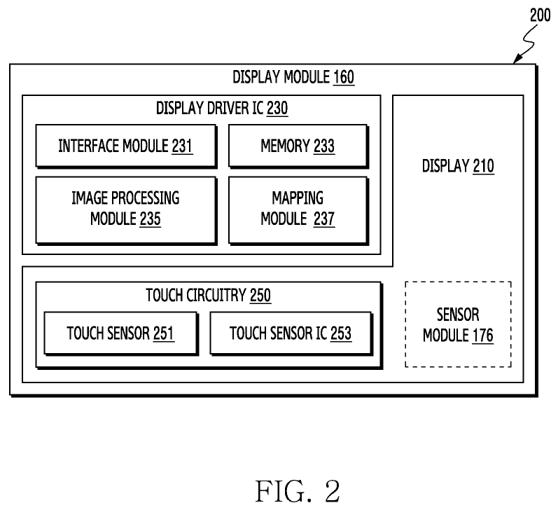

FIG. 2 is a block diagram 200 illustrating the display module 160 according to various embodiments.

Referring to FIG. 2, the display module 160 may include a display 210 and a display driver integrated circuit (DDI) 230 to control the display 210. The DDI 230 may include an interface module 231, memory 233 (e.g., buffer memory), an image processing module 235, and a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

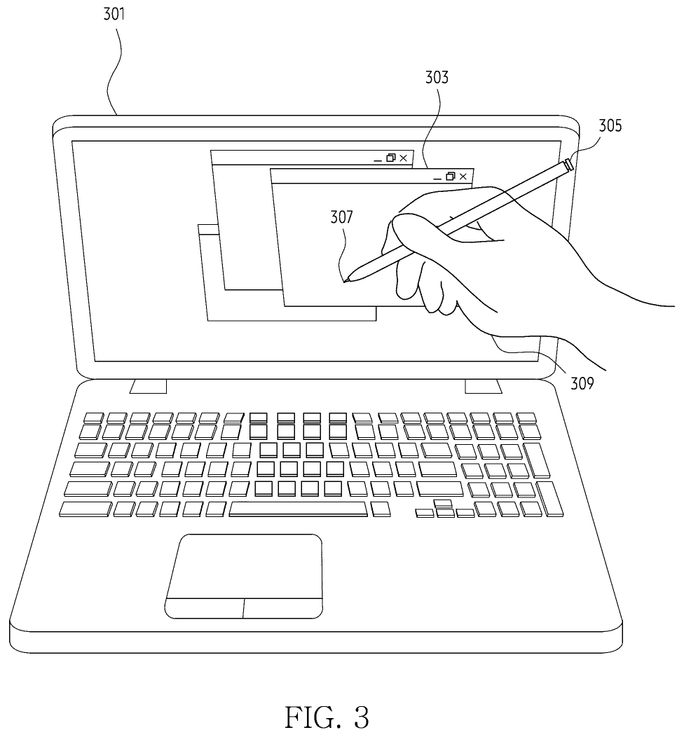

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer. FIG. 3 is an example of an electronic device for receiving a user input.

Referring to FIG. 3, an electronic device 301 (e.g., the electronic device 101 of FIG. 1) may include a display (e.g., the display module 160 of FIG. 2) that receives a user input. A first window 303 may be activated. Hereinafter, an activated window may be referred to as an active window. The display 160 may obtain a pen input through a pen input device 305. The pen input intended through contact between the pen input device 305 and the display at a pen input point 307 may occur. At a touch input point 309, an unintended touch input may occur through contact between a hand of a user and the display 160.

According to an embodiment, the display 160 may receive the pen input by the pen input device 305. While generating the pen input by the pen input device 305, the user may generate the unintended touch input. For example, while an electronic device 101 receives the pen input of the user, a part (e.g., a palm) of a body of the user may be in contact with the display. For example, while a memo is written through the pen input device in the memo pad, a touch input by a finger of the user may occur. For example, while selecting an icon through the pen input device, a touch input by a user's wrist touching the display may occur. The electronic device 101 may perform an operation due to an unintended touch input caused by the part of the body of the user. In order to reduce unintended actions (or malfunction) caused by the unintended touch input, the electronic device 301 may filter out designated touch inputs. In order to reduce the unintended actions caused by the unintended touch input, the electronic device 301 may filter out a touch input in another area different from an active window area. In other words, the electronic device 101 may block the touch input in the other area different from the active window area. A touch input may mean inputs (e.g., a press input, a drag input, or a gesture input, and the like) by the part of the body of the user excluding the pen input. The active window (e.g., the first window 303) may be a window in which a task is being performed. The active window may be a window positioned at the topmost layer among a plurality of displayed windows. The active window area may be a portion occupied by the active window on the display 160. The active window area may be an internal area defined by a coordinate of vertices of the active window. The electronic device 301 may filter out a touch input through a filter driver included in a touch screen driver. When the pen input occurs, since a user input that is not a touch input is rarely unintentionally generated, the electronic device 301 may not filter out the user input that is not the touch input.

According to an embodiment, the electronic device 301 may display a plurality of windows through the display 160. The electronic device 301 may activate the first window 303 among the plurality of windows. The electronic device 301 may set the first window 303 as an active window. While the first window 303 is activated, the electronic device 301 may set the touch screen driver to refrain from recognizing a touch input in the other area different from the area of the first window 303. While the first window 303 is activated, the electronic device 301 may perform, based on receiving a touch input in the area of the first window 303, a function corresponding to the touch input. While the first window 303 is activated, the electronic device 301 may perform a function corresponding to a user input that is not a touch input in the other area different from the area of the first window 303.

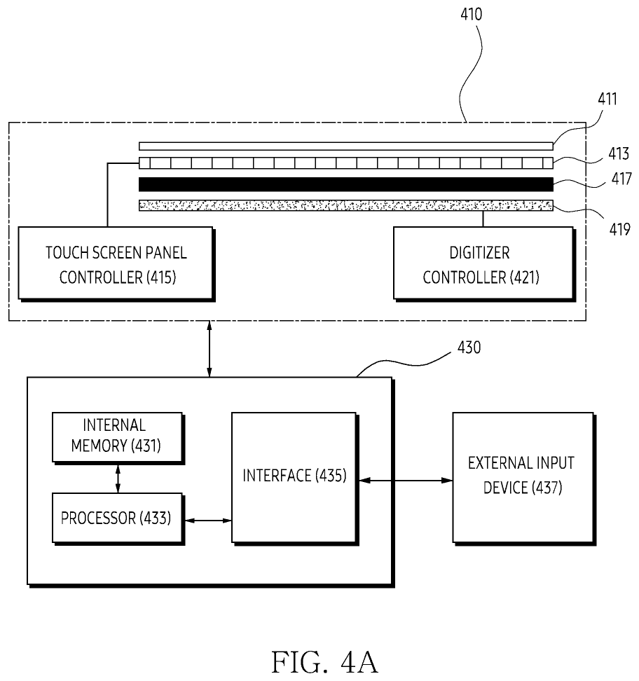

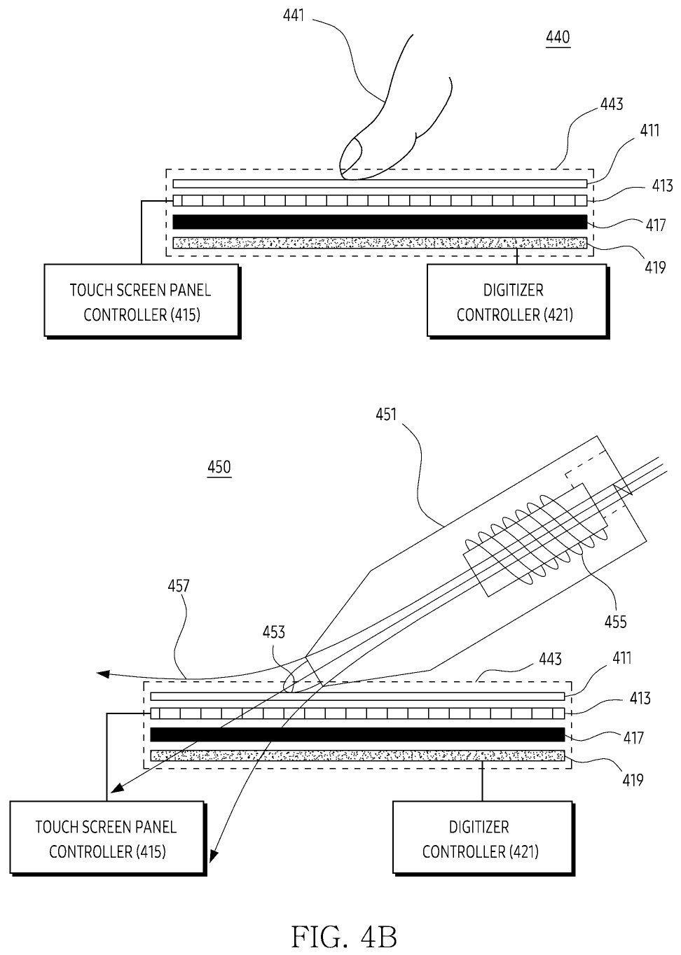

FIG. 4A is an example of a cross-section of a display including a touch screen and a digitizer.

Referring to FIG. 4A, according to an embodiment, an electronic device (e.g., the electronic device 101 of FIG. 1) may include a display 410 and a host device 430. The display 410 may include a screen window 411, a touch screen panel 413, a touch screen panel controller 415, a display panel 417, a digitizer panel 419, and a digitizer controller 421. The host device 430 may include internal memory 431, at least one processor 433, and an interface 435. An external input device 437 may be connected to the electronic device 101 through the host device 430.

According to an embodiment, the display 410 may perform a data input function between the electronic device 101 and a user, by providing an input interface. The display 410 may perform a data output function between the electronic device 101 and the user, by providing an output interface. For example, the display 410 may transmit a user input to the host device 430. For example, the display 410 may transmit a touch input to the host device 430. For example, the display 410 may transmit a mouse input to the host device 430. The display 410 may display visual information such as text, a graphic, and a video provided from the host device 430, based on the user input transmitted to the host device 430.

According to an embodiment, the display 410 may have a structure in which the screen window 411, the touch screen panel 413, the touch screen panel controller 415, the display panel 417, the digitizer panel 419, and the digitizer controller 421 are sequentially stacked.

According to an embodiment, the screen window 411 may be a portion in which a part of the human body or a pen input device (e.g., the pen input device 305 of FIG. 3) for generating a user input (e.g., the pen input, the touch input) is in contact with the display. The screen window 411 may be glass treated with a reinforced coating or an olcophobic coating. The screen window 411 may also be formed using at least one of alumina, silica, and sapphire materials. The screen window 411 may be made of a transparent material. The screen window 411 may form an external appearance of the electronic device 101. The screen window 411 may be attached to the touch screen panel 413 by using an adhesive. The adhesive may be a super view resin. The adhesive may be an optically clear adhesive. The touch screen panel 413 may be formed by crossing electrode lines. The touch screen panel may apply a voltage from the touch screen panel controller 415. According to an embodiment, the display may detect a touch point as an input coordinate through a change in capacitance according to a touch input of the touch screen panel 413. The touch screen panel controller 415 may provide a location of the touch point to the host device 430, based on charge amount obtained from a receiving electrode. The processor 433 of the host device 430 may perform a function corresponding to the location of the touch point. The processor 433 of the host device 430 may display a user interface by controlling the display panel 417.

The digitizer panel 419 may include an FPCB including a plurality of loop antenna coils overlapped in a direction of X-axis and Y-axis arrangements. The digitizer panel 419 may be applied with a voltage from the digitizer controller 421. The digitizer panel 419 may generate an electromagnetic field through the applied voltage. A shield plate for a noise reduction may be included on a rear surface of the digitizer panel 419. The digitizer controller 421 may receive information on a pen input coordinate and pen pressure of a pen input device 305. When the pen input device contacts or approaches the digitizer panel 419, a resonance circuit included in the pen input device 305 may generate a current. In the resonance circuit, a magnetic field may be formed by the generated current. The digitizer controller 421 may identify a location where a pen input has occurred based on a change in an intensity of the magnetic field by the pen input device. The digitizer controller 421 may transmit the location of the point where the pen input has occurred to the host device 430. The processor 433 of the host device 430 may output a function corresponding to the pen input to the display panel 417. For example, the processor 433 of the host device 430 may display the visual information such as the text, the graphic, and the video on the display 410 by controlling the display panel 417. The processor 433 of the host device 430 may output a screen generated based on coordinate information, the pen pressure of the pen input device 305, an inclination angle, and an inclination direction, through the display panel 417.

According to an embodiment, the host device 430 may include the internal memory 431, the at least one processor 433, and the interface 435. The internal memory 431 may include a conversion table for correcting the coordinate. The processor 433 may execute a software program to perform processing for a voice, an image, and/or data communication. The processor 433 may execute the software program to perform processing for the voice. The processor 433 may execute the software program to perform processing for the image. The processor 433 may execute the software program to perform processing for the data communication. The interface 435 may connect the external input devices 437 of the electronic device 101 and the host device 430. For example, the external input device 437 may be a camera. For example, the external input device 437 may be a sensor. For example, the external input device 437 may be a microphone.

FIG. 4B is an example of a cross-section of a display for receiving a touch input and a pen input. Since a display 443 of FIG. 4B may be the display 410 of FIG. 4A, a redundant description thereof will be omitted.

Referring to FIG. 4B, in a state 440, the display (e.g., the display module 160 of FIG. 1) may receive a touch input. A touch input by a human body 441 (e.g., a hand of the user) of the user may be received through the touch screen panel 413. The display 443 may include the screen window 411, the touch screen panel 413, the touch screen panel controller 415, the display panel 417, the digitizer panel 419, and the digitizer controller 421.

According to an embodiment, the touch screen panel 413 may be a capacitive type. For example, the touch screen panel 413 may include a plurality of electrode lines formed in up, down, left, and right directions. In case that a touch input occurs at any point on the touch screen panel 413, capacitance of some of the plurality of electrode lines may increase. The electronic device 101 may identify a location of a point where the touch input occurs based on a location of the electrode line in which the capacitance has increased.

In a state 450, the display may receive a pen input. The pen input by the pen input device 451 may be received through the digitizer panel 419. The pen input device 451 may include a tip 453 and a resonance circuit 455. The resonance circuit 455 may generate a magnetic field 457.

According to an embodiment, the digitizer controller 421 may provide a current to the digitizer panel 419. The digitizer panel 419 may generate the electromagnetic field. When the pen input device 451 approaches the digitizer panel 419, electromagnetic induction may occur. The resonance circuit 455 may generate the current by the electromagnetic induction. The resonance circuit 455 may form the magnetic field 457 by the generated current. The digitizer controller 421 may identify a contact location of the pen input by detecting a change in the magnetic field 457. The digitizer controller 421 may transmit the contact location to a host device (e.g., the host device 430 of FIG. 4A) not illustrated. The host device 430 may perform a function corresponding to the pen input. The host device 430 may output the corresponding function to the display panel. The processor (e.g., the processor 433 of FIG. 4A) of the host device 430 may display the visual information such as the text, the graphic, and the video on the display 443 by controlling the display panel 417.

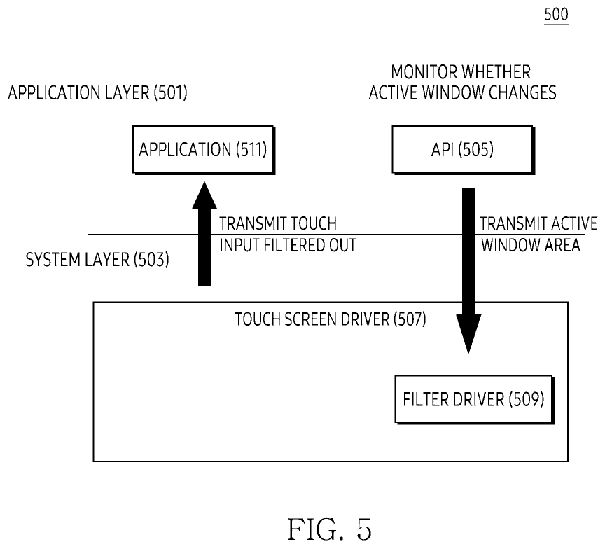

FIG. 5 is an example of an electronic device for filtering out a touch input. The electronic device (e.g., the electronic device 101) may filter out a touch input in a certain area among user inputs.

Referring to FIG. 5, an electronic device 101 may include an application layer 501 and a system layer 503. The application layer 501 may be managed by an operating system and may provide a user service by using a resource. The application 511 may be executed in the application layer 501. In the application layer 501, an application programming interface (API) for monitoring whether an active window changes may be executed. The system layer 503 may be the operating system (OS) that controls an operation of hardware. The system layer 503 may perform a function such as hardware management, memory, and security. The system layer may include a setting configured by a touch screen driver 507 for controlling a touch screen panel. The system layer 503 may include a setting configured by a filter driver 509 for filtering out the touch input. The touch screen driver 507 may include the filter driver 509, by filtering out a touch input in another area different from an active window area, for providing the touch input to the application layer 501.

According to an embodiment, at least one processor (e.g., the processor 120 of FIG. 1) may display a plurality of windows through a display. The electronic device 101 may set a first window as an active window to prevent an unintended action, by activating the first window (e.g., the first window 303 of FIG. 3) among the plurality of windows.

According to an embodiment, the electronic device 101 may obtain coordinate information on an area of the first window 303 through the API 505. The coordinate information may include coordinate information of vertices of the first window 303. The area of the first window 303 may be an interior of an area determined through the coordinate information.

According to an embodiment, the electronic device 101 may monitor whether the active window is changed through the API 505. Hereinafter, when changing the active window from the first window 303 to a second window, the electronic device 101 may identify the area of the second window, thereby inputting it to the touch screen driver 507. When changing the active window from the first window 303 to the second window, the electronic device 101 may identify the area of the second window, thereby inputting it to the filter driver 509. For example, the electronic device 101 may monitor whether the active window is changed through an event hook method. The event hook method may be a method of identifying an event when the event occurs in the system. When the event in which the active window is changed occurs, the electronic device 101 may identify the event. For example, the electronic device 101 may monitor whether the active window is changed through a polling method. The polling method may be a method of periodically checking an active window ID and comparing the active window ID with a previous active window ID. In case that the active window ID is changed, the electronic device 101 may identify that the active window is changed.

According to an embodiment, the electronic device 101 may input an active window area (e.g., the area of the first window 303) to the filter driver 509 through the API 505. The filter driver 509 may be included in the touch screen driver 507. While the first window 303 is activated, the filter driver 509 may refrain from recognizing a touch input in another area different from the area of the first window 303. While the first window 303 is activated, the electronic device 101 may perform a function corresponding to a first user input based on receiving the first user input in the area of the first window 303. The first user input may include a pen input, a touch input, and a mouse input. While the first window 303 is activated, the electronic device 101 may perform a function corresponding to a second user input based on receiving the second user input that is not a touch input in the other area different from the area of the first window 303. The second user input may include the pen input and the mouse input. While the first window 303 is activated, the filter driver 509 may not transmit information on a touch input to the application 511, based on receiving the touch input in the other area different from the area of the first window 303. While the first window 303 is activated, the filter driver 509 may not transmit the information on the touch input to the application 511, even if the touch input is received in the other area different from the area of the first window 303. The filter driver 509 may filter out the touch input in the other area different from the area of the first window 303, which is an active area. While generating a pen input through a pen input device 305, the user may generate an unintended touch input. In order to reduce unintended actions caused by the unintended touch input, the filter driver 509 may filter out a touch input in an area different from the area of the first window 303 in which a task is being executed. While the pen input occurs, a possibility of a user input (e.g., a mouse input, a pen input) other than the unintended touch input occurring may be relatively low compared to a possibility of the unintended touch input occurring. Therefore, the filter driver 509 may not filter out the user input that is not the touch input, even if the user input that is not the touch input occurs in the other area different from the area of the first window 303.

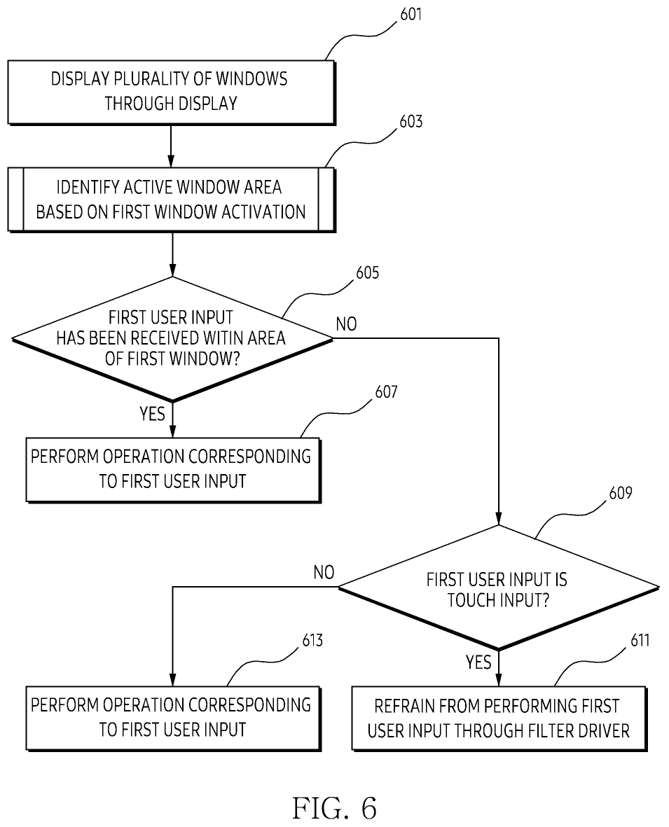

FIG. 6 is a flow of an operation of an electronic device for filtering out a user input. Operations of the electronic device (e.g., the electronic device 101 of FIG. 1) may be performed by at least one processor (e.g., the processor 120 of FIG. 1).

Referring to FIG. 6, in an operation 601, an electronic device 101 may display a plurality of windows through a display (e.g., the display module 160 of FIG. 1, the display 410 of FIG. 4A, and the display 443 of FIG. 4B). For example, one of the plurality of windows may be a window of a website. For example, one of the plurality of windows may be a window of Windows. For example, one of the plurality of windows may be an application window.

In an operation 603, the electronic device 101 may identify an active window area based on a first window activation. The electronic device 101 may set a first window (e.g., the first window 303 of FIG. 3) as an active window. The electronic device 101 may identify the active window area through an application programming interface (API). While the electronic device 101 receives a pen input of a user, a part (e.g., a palm) of a body of the user may be in contact with the display. The electronic device 101 may perform an operation by an unintended touch input caused by the part of the body of the user. In order to reduce unintended actions caused by the unintended touch input, the electronic device 101 may filter out a touch input in another area different from the active window area. In other words, the electronic device 101 may block the touch input in the other area different from the active window area. The touch input may mean inputs (e.g., a press input, a drag input, or a gesture input, and the like) by the part of the body of the user excluding the pen input.

According to embodiments, the electronic device 101 may identify the first window designated as the active window, in order to filter out the touch input in the other area different from the active window area. According to an embodiment, the electronic device 101 may identify the first window 303 set as the active window based on a third user input. For example, the third user input may be a pen input. The third user input may be a mouse input. According to an embodiment, the user may set one of a plurality of windows being executed as the active window. For example, the user may set one of the plurality of windows being executed through the pen input as the active window. For example, the user may set one of the plurality of windows being executed through the mouse input as the active window.

According to an embodiment, the electronic device 101 may identify the first window set as the active window based on a state of the plurality of windows. For example, the electronic device 101 may set the topmost window as the active window. For example, the electronic device 101 may set a window in which a task was performed lastly among a plurality of open windows as the active window. For example, the electronic device 101 may set the last executed window among the plurality of open windows as the active window.

According to an embodiment, the electronic device 101 may set a filter driver (e.g., the filter driver 509 of FIG. 5) to refrain from recognizing a touch input. A processor of an application layer (e.g., the application layer 501 of FIG. 5) may input information on the active window area (e.g., the area of the first window 303) to the filter driver 509, which is a system layer (e.g., the system layer 503 of FIG. 5), through the application programming interface (the API 505 of FIG. 5). The filter driver 509 may be included in the touch screen driver (e.g., the touch screen driver 507 of FIG. 5). While the first window 303 is activated, the filter driver 509 may be set to refrain from recognizing the touch input in the other area different from the area of the first window 303.

In an operation 605, the electronic device 101 may identify whether a first user input has been received in the area of the first window 303. In case that the first user input is received in the area of the first window 303, the electronic device 101 may perform an operation 607. For example, the first user input may be a touch input. For example, the first user input may be a pen input. For example, the first user input may be a mouse input. The area of the first window 303 may be an active window area. In case that the first user input is received in the other area different from the area of the first window 303, the electronic device 101 may perform an operation 609.

In the operation 607, the electronic device 101 may perform an operation corresponding to the first user input. According to an embodiment, the electronic device 101 may perform an operation corresponding to a touch input. For example, the electronic device 101 may move a cursor in a memo pad in response to a touch input on a point in the memo pad. For example, the electronic device 101 may select an address window in response to a touch input on a point where the address window is located. For example, the electronic device 101 may select a menu in the window of Windows in response to a touch input on the inside of the window of Windows. According to an embodiment, the electronic device 101 may perform an operation corresponding to the mouse input. For example, the electronic device 101 may move the cursor in the memo pad in response to a mouse input on a point in the memo pad. For example, the electronic device 101 may select the address window in response to a mouse input on the point where the address window is located. For example, the electronic device 101 may select the menu in the window of Windows in response to a mouse input on the inside of the window of Windows. According to an embodiment, the electronic device 101 may perform an operation corresponding to the pen input. For example, the electronic device 101 may move the cursor in the memo pad in response to a pen input on a point in the memo pad. For example, the electronic device 101 may select the address window in response to a pen input on the point where the address window is located. For example, the electronic device 101 may select the menu in the window of Windows in response to a pen input on the inside of the window of Windows.

In the operation 609, the electronic device 101 may identify whether the first user input is the touch input. In case that the first user input is the touch input, the electronic device 101 may perform an operation 611. In case that the first user input is not the touch input, the electronic device 101 may perform an operation 613.

According to an embodiment, in case that the first user input occurs in the other area different from the area of the first window, the electronic device 101 may identify whether the first user input is the touch input. When a pen input occurs, since a case that a user input that is not a touch input is rarely unintentionally generated, the electronic device 101 may not filter out the first user input that is not the touch input.

In the operation 611, the electronic device 101 may refrain from performing the first user input through the filter driver. The first user input may be a touch input. According to an embodiment, while the first window 303 is activated, the electronic device 101 may receive the first user input, which is the touch input, in the other area different from the area of the first window 303. The electronic device 101 may refrain from performing the first user input, which is the touch input, through the filter driver 509, based on receiving the first user input, which is the touch input. For example, while the first window is activated, the filter driver 509 may filter out information on the touch input in the other area different from the area of the first window based on receiving the touch input in the other area different from the area of the first window.

According to an embodiment, in order to reduce unintended actions caused by the unintended touch input, the electronic device 101 may filter out the touch input in the other area different from the active window area. While generating a pen input by a pen input device 305, the user may generate the unintended touch input. For example, while the electronic device 101 receives the pen input of the user, the part (e.g., the palm) of the body of the user may be in contact with the display. For example, while a memo is written through a pen input device in the memo pad, a touch input by a finger of the user may occur. For example, while selecting an icon through the pen input device, a touch input by a user's wrist touching the display may occur. In order to reduce unintended actions caused by the unintended touch input by a part of the body of the user, the electronic device 101 may filter out designated touch inputs. In other words, the electronic device 101 may block the touch input in the other area different from the active window area. The touch input may mean inputs (e.g., a press input, a drag input, or a gesture input, and the like) by the part of the body of the user excluding the pen input.

In the operation 613, the electronic device 101 may perform an operation corresponding to the first user input.

According to an embodiment, while the first window 303 is activated, the electronic device 101 may receive the first user input that is not a touch input in the other area different from the area of the first window 303. The electronic device 101 may perform a function corresponding to the first user input that is not the touch input, based on receiving the first user input that is not the touch input.

According to an embodiment, the electronic device 101 may perform an operation corresponding to the mouse input. For example, the electronic device 101 may move the cursor in the memo pad in response to the mouse input on a point in the memo pad. For example, the electronic device 101 may select the address window in response to a mouse input on a point where the address window is located. For example, the electronic device 101 may select the menu in the window of Windows in response to a mouse input on the inside of the window of Windows. According to an embodiment, the electronic device 101 may perform an operation corresponding to the pen input. For example, the electronic device 101 may move the cursor in the memo pad in response to a pen input on a point in the memo pad. For example, the electronic device 101 may select the address window in response to a pen input on a point where the address window is located. For example, the electronic device 101 may select the menu in the window of Windows in response to a pen input on the inside of the window of Windows.

FIG. 5 illustrates only a case where the active window is the first window, but embodiments of the present disclosure are not limited thereto. According to an embodiment, the electronic device may execute a plurality of active windows. For example, the electronic device 101 may set both the first window and a second window as an active window. While the first window and the second window are activated, the electronic device 101 may set the touch screen driver to refrain from recognizing a touch input in other areas different from areas of the first window and the second window. While the first window and the second window are activated, the electronic device 101 may perform a function corresponding to the first user input based on receiving the first user input in the first window area and/or the second window area. While the first window and the second window are activated, based on receiving a second user input that is not the touch input, the electronic device 101 may perform a function corresponding to the second user input that is not the touch input, in the other areas different from the areas of the first window and the second window.

While generating a pen input by a pen input device (e.g., the pen input device 305 of FIG. 3), the user may generate an unintended touch input. While a memo is written through the pen input device in the memo pad, a touch input by a finger of the user may occur. For example, while selecting an icon through the pen input device, a touch input by a user's wrist touching a display may occur.

According to an embodiment, in order to reduce unintended actions caused by the unintended touch input, the electronic device 101 may filter out designated touch inputs. For example, in order to reduce unintended actions caused by the unintended touch input, the filter driver 509 may filter out a touch input in another area different from an area of the first window 303 in which a task is being executed.

According to an embodiment, the user may execute the task through the pen input. While the pen input occurs, a possibility of a user input (e.g., the mouse input, the pen input) other than the unintended touch input occurring may be relatively low compared to a possibility of the unintended touch input occurring. Therefore, for user convenience, the filter driver 509 may not filter out the user input that is not the touch input, even if the user input that is not the touch input occurs in the other area different from the area of the first window 303.

According to an embodiment, the user may intend to generate a touch input in the area of the first window in which the task is being executed. Therefore, for user convenience, the filter driver 509 may not filter out the user input, including the touch input in the area of the first window in which the task is being executed.

According to an embodiment, the filter driver 509 may be included in a system layer. The filter driver 509 may transmit a touch input to a processor of an application layer 501 by filtering out the touch input received from a touch screen panel (e.g., the touch screen panel 413 of FIG. 4A). The filtered touch input may not be transmitted from the filter driver 509 to the processor of the application layer 501.

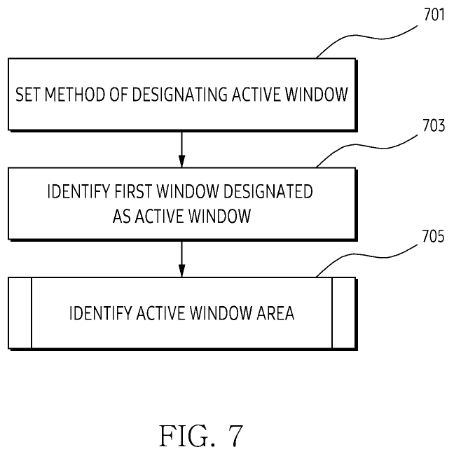

FIG. 7 is a flow of an operation of an electronic device for identifying an activated first window. Operations of FIG. 7 may correspond to the operation 603 of the electronic device of FIG. 6.

Referring to FIG. 7, in an operation 701, the electronic device (e.g., the electronic device 101 of FIG. 1) may set a method of designating an active window. According to an embodiment, the electronic device 101 may display a user interface (UI) for determining the method of designating the active window. For example, the UI may enable a user to designate one of a plurality of methods of designating the active window. The user may generate a fourth user input for designating one of the plurality of methods of designating the active window. According to an embodiment, the electronic device 101 may determine the method of designating the active window based on the fourth user input. The electronic device 101 may set the active window to be designated based on a third user input. The third user input may be a pen input. The third user input may be a mouse input. For example, the third user input may be a keyboard input. For example, the electronic device 101 may set the topmost window as the active window. For example, the electronic device 101 may set a window being executed as the active window. The electronic device 101 may improve a user experience by setting the active window in an intuitive manner.

According to an embodiment, the electronic device 101 may receive the fourth user input from a system layer. The electronic device 101 may set the method of designating the active window based on the fourth user input in an application layer. According to an embodiment, the electronic device 101 may receive the third user input from the system layer. The electronic device 101 may designate the active window based on the third user input in the application layer.

In an operation 703, the electronic device 101 may identify the first window designated as the active window. According to an embodiment, the electronic device 101 may determine the first window as the active window by the method designated in the operation 701.

According to an embodiment, the electronic device 101 may identify the first window set as the active window based on the third user input. For example, the third user input may be a pen input. For example, the third user input may be a mouse input. For example, the third user input may be a keyboard input. According to an embodiment, the user may set one of a plurality of windows being executed as the active window. For example, the user may set one of the plurality of windows being executed as the active window through the pen input. For example, the user may set one of the plurality of windows being executed as the active window through the mouse input. According to an embodiment, the third user input may not be a touch input. When the user changes the active window area from the first window to a second window, generation of a user input for the second window may be requested. When the user changes the active window area from the first window to the second window, a touch input may be filtered out in another area different from an area of the first window, which is the active area. Therefore, the third user input may be the mouse input, the pen input, or the keyboard input. However, the third user input cannot be a touch input.

According to another embodiment, the electronic device 101 may identify the first window set as the active window based on a state of the plurality of windows. For example, the electronic device 101 may set the topmost window as the active window. For example, the electronic device 101 may set a window in which a task was performed lastly among a plurality of open windows as the active window. For example, the electronic device 101 may set the last executed window among the plurality of open windows as the active window. The electronic device 101 may improve the user experience by setting the active window in the intuitive manner. According to an embodiment, the electronic device 101 may identify a touch input with a high possibility of being an intended touch input among the received touch inputs by designating the active window.

According to an embodiment, the electronic device 101 may receive the third user input from the system layer. The electronic device 101 may designate the active window based on the third user input in the application layer.

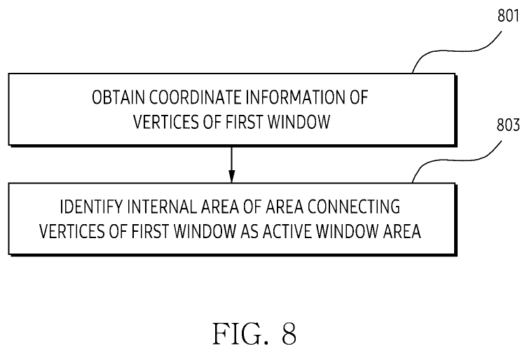

In an operation 705, the electronic device 101 may identify the active window area. The electronic device 101 may identify the active window area through an application programming interface (API). The application programming interface (API) means a language format or a message format used for communication between an operating system and an application program. The electronic device 101 may identify the active window area based on a range, a width, and the like of the active window. The electronic device 101 may identify the active window area based on a coordinate of each of vertices of the active window. According to an embodiment, the electronic device 101 may identify the active window area in the application layer. The electronic device 101 may receive active window area information as a filter driver of the system layer by identifying the active window area. Hereinafter, operations of FIG. 8 may be referred to.

According to an embodiment, the electronic device 101 may determine whether to filter out according to a location where a touch input occurs by identifying the active window area.

FIG. 8 is a flow of an operation of an electronic device for identifying an active window area. Operations of FIG. 8 may correspond to the operation 705 of the electronic device of FIG. 7.

Referring to FIG. 8, in an operation 801, an electronic device 101 may obtain coordinate information of vertices of a first window (e.g., the first window 303 of FIG. 3). The vertices of a first window 303 may be points at which a distance from a center of the first window 303 is the farthest. For example, the vertices of the first window 303 may be four vertices of a quadrangle that forms a shape of the first window 303. According to an embodiment, the electronic device 101 may identify a boundary of the first window by obtaining the coordinate information of the vertices of the first window 303. For example, the four vertices forming the shape of the first window 303 may be identified by obtaining a coordinate of the four vertices of the quadrangle constituting the shape of the first window 303.

In an operation 803, the electronic device 101 may identify an internal area of an area connecting the vertices of the first window as the active window area. In order to reduce unintended actions caused by an unintended touch input, the electronic device 101 may filter out a touch input in another area different from the active window area. According to an embodiment, the electronic device 101 may identify the boundary of the first window through a line connecting the vertices. The internal area of the area connecting the vertices may have a closed figure. For example, the internal area of the area connecting the vertices may be a quadrangle. For example, the internal area of the area connecting the vertices may be a pentagon. For example, the internal area of the area connecting the vertices may be hexagonal. The internal area of the area connecting the vertices may be the area of the first window. The electronic device 101 may determine whether to filter out according to the location where the touch input occurs by identifying the area of the first window as the active window area.

Although FIG. 8 illustrates that the active window area is identified based on the coordinate of the vertices of the first window, embodiments of the present invention are not limited thereto. According to an embodiment, the electronic device 101 may identify the active window area based on information such as a range and a width of the active window, and a coordinate of an active window center point.

As described above, according to an embodiment, an electronic device may comprise a display 160, 410, or 443, and at least one processor 120. The electronic device may comprise the display 160, 410, or 443. The electronic device may comprise the at least one processor 120. The display 160, 410, or 443 may comprise a display panel 417 and a touch screen panel 413. The display 160, 410, or 443 may comprise the touch screen panel 413. The display 160, 410, or 443 may comprise the touch screen panel 413. The at least one processor 120 may include a setting configured by a touch screen driver 507. The at least one processor 120 may display a plurality of windows through the display 160, 410, or 443. The at least one processor 120 may set a first window 303 as an active window by activating the first window among the plurality of windows. The at least one processor 120 may, while the first window 303 is activated, set the touch screen driver 507 to refrain from recognizing a touch input in another area different from an area of the first window 303. The at least one processor 120 may, while the first window 303 is activated, perform a function corresponding to a first user input based on receiving the first user input within the area of the first window 303. The at least one processor 120 may, while the first window 303 is activated, perform a function corresponding to a second user input that is not a touch input based on receiving, in the another area different from the area of the first window 303, the second user input that is not the touch input.

According to an embodiment, the first window 303 may be positioned at the topmost layer among the plurality of windows.

According to an embodiment, the first window 303 may be set based on a third user input for selecting an active window area among the plurality of windows.

According to an embodiment, the electronic device may further comprise a digitizer. The second user input may include a pen input received through the digitizer.

According to an embodiment, the at least one processor 120 may identify the first window 303 among the plurality of windows to activate the first window 303. The at least one processor 120 may obtain coordinate information on the area of the first window 303 to activate the first window 303. The at least one processor 120 may activate the first window 303. The coordinate information includes coordinate information of vertices of the first window 303 to activate the first window 303. The at least one processor 120 may determine an internal area determined through the coordinate information as an active area to activate the first window 303.

According to an embodiment, the at least one processor 120 may provide information on the area of the first window 303 to the touch screen driver 507, to set the touch screen driver 507 to refrain from recognizing a touch input in another area different from the area of the first window 303. The at least one processor 120 may set the touch screen driver 507 to filter out a touch input within the another area different from the area of the first window 303 among at least one touch input to set the touch screen driver 507 to refrain from recognizing a touch input in another area different from the area of the first window.

According to an embodiment, when the active window is changed from the first window 303 to a second window, the at least one processor 120 may further set the touch screen driver 507 to refrain from recognizing a touch input in another area different from an area of the second window while the second window is activated.

According to an embodiment, the at least one processor 120 may monitor whether an active window change event has occurred, to identify whether the active window is changed from the first window 303 to the second window.

According to an embodiment, the touch screen driver 507 may include a filter driver 509 for providing a touch input to an application layer by filtering out the touch input in another area different from an active window area. The filter driver 509 may further, while the first window 303 is activated, based on receiving a touch input in another area different from the area of the first window 303, filters out information on the touch input in the another area different from the area of the first window 303.

According to an embodiment, the at least one processor 120 may set both the first window 303 and a second window among the plurality of windows as active windows. The at least one processor 120 may further, while the first window 303 and the second window are activated, set the touch screen driver 507 to refrain from recognizing a touch input in areas different from areas of the first window 303 and the second window. The at least one processor 120 may further, while the first window 303 and the second window are activated, perform a function corresponding to the first user input based on receiving the first user input within the areas of the first window 303 and the second window. The at least one processor 120 may further, while the first window 303 and the second window are activated, perform a function corresponding to a second user input that is not a touch input based on receiving, in the areas different from the areas of the first window 303 and the second window, the second user input that is not the touch input.

As described above, according to an embodiment, a method performed by an electronic device may comprise displaying a plurality of windows through a display 160, 410, or 443. The method may comprise setting a first window as an active window by activating the first window 303 among the plurality of windows. The method may comprise while the first window 303 is activated, setting a touch screen driver 507 to refrain from recognizing a touch input in another area different from an area of the first window 303. The method may comprise while the first window 303 is activated, performing a function corresponding to a first user input based on receiving the first user input within the area of the first window 303. The method may comprise while the first window 303 is activated, performing a function corresponding to a second user input that is not a touch input based on receiving, in the another area different from the area of the first window 303, the second user input that is not the touch input.

According to an embodiment, the first window 303 may be positioned at the topmost layer among the plurality of windows.

According to an embodiment, the first window 303 may be set based on a third user input for selecting an active window area among the plurality of windows.

According to an embodiment, the second user input may include a pen input received through a digitizer.

According to an embodiment, the activating the first window 303 may comprise identifying the first window 303 among the plurality of windows. The activating the first window 303 may comprise obtaining coordinate information on the area of the first window 303. The activating the first window 303 may comprise the coordinate information including coordinate information of vertices of the first window 303. The activating the first window 303 may comprise determining an internal area determined through the coordinate information as an active area.

According to an embodiment, setting the touch screen driver 507 to refrain from recognizing a touch input in another area different from the area of the first window 303 may comprise providing information on the area of the first window 303 to the touch screen driver 507. The setting the touch screen driver 507 to refrain from recognizing a touch input in another area different from the area of the first window 303 may comprise setting the touch screen driver 507 to filter out a touch input within the another area different from the area of the first window 303 among at least one touch input.

According to an embodiment, the method may further comprise, when the active window is changed from the first window 303 to a second window, setting the touch screen driver 507 to refrain from recognizing a touch input in another area different from an area of the second window while the second window is activated.

According to an embodiment, identifying whether the active window is changed from the first window 303 to the second window, may comprise monitoring whether an active window change event has occurred.

According to an embodiment, the touch screen driver 507 may further include a filter driver 509 for providing a touch input to an application layer by filtering out the touch input in another area different from an active window area. The method may further include, while the first window 303 is activated, based on receiving a touch input in another area different from the area of the first window 303, filtering out information on the touch input in the another area different from the area of the first window 303.

According to an embodiment, the method may further comprise setting both the first window 303 and a second window among the plurality of windows as active windows. The method may further comprise, while the first window 303 and the second window are activated, setting the touch screen driver 507 to refrain from recognizing a touch input in areas different from areas of the first window 303 and the second window. The method may further comprise, while the first window 303 and the second window are activated, performing a function corresponding to the first user input based on receiving the first user input within the areas of the first window 303 and the second window. The method may further comprise, while the first window 303 and the second window are activated, performing a function corresponding to a second user input that is not a touch input based on receiving, in the areas different from the areas of the first window 303 and the second window, the second user input that is not the touch input.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions;
a display; and
at least one processor comprising processing circuitry,
wherein the display includes:
a display panel; and
a touch screen panel,
wherein the instructions, when executed by the at least one processor, cause the electronic device to:
display a plurality of windows through the display;
set a first window as an active window by activating the first window among the plurality of windows;
while the first window is activated, set a touch screen driver to refrain from recognizing a touch input in another area different from an area of the first window;
while the first window is activated, perform a function corresponding to a first user input based on receiving the first user input within the area of the first window; and
while the first window is activated, perform a function corresponding to a second user input that is not a touch input based on receiving, in the another area different from the area of the first window, the second user input that is not the touch input.

2. The electronic device of claim 1, wherein the first window is positioned at a topmost layer among the plurality of windows.

3. The electronic device of claim 1, wherein the first window is set as the active window based on a third user input for selecting an active window area among the plurality of windows.

4. The electronic device of claim 1, further comprising a digitizer, wherein the second user input includes a pen input received through the digitizer.

5. The electronic device of claim 1, wherein, to activate the first window, the instructions, when executed by the at least one processor, cause the electronic device to:
identify the first window among the plurality of windows;
obtain coordinate information on the area of the first window, the coordinate information including coordinate information of vertices of the first window; and
determine an internal area determined through the coordinate information as an active area.

6. The electronic device of claim 1, wherein, to set the touch screen driver to refrain from recognizing a touch input in another area different from the area of the first window, the instructions, when executed by the at least one processor, cause the electronic device to:
provide information on the area of the first window to the touch screen driver; and
set the touch screen driver to filter out a touch input within the another area different from the area of the first window among at least one touch input.

7. The electronic device of claim 1, wherein the instructions, when executed by the at least one processor, cause the electronic device to set the touch screen driver to refrain from recognizing a touch input in another area different from an area of the second window while the second window is activated when the active window is changed from the first window to a second window.

8. The electronic device of claim 1, wherein, to identify whether the active window is changed from the first window to the second window, the instructions, when executed by the at least one processor, cause the electronic device to monitor whether an active window change event has occurred.

9. The electronic device of claim 1, wherein the touch screen driver includes a setting configured by a filter driver for providing a touch input to an application layer by filtering out the touch input in another area different from an active window area, and
wherein the filter driver is further configured such that, while the first window is activated, based on receiving a touch input in another area different from the area of the first window, the filter driver filters out information on the touch input in the another area different from the area of the first window.

10. The electronic device of claim 1, wherein the instructions, when executed by the at least one processor, cause the electronic device to:
set both the first window and a second window among the plurality of windows as active windows;
while the first window and the second window are activated, set the touch screen driver to refrain from recognizing a touch input in areas different from areas of the first window and the second window;
while the first window and the second window are activated, perform a function corresponding to the first user input based on receiving the first user input within the areas of the first window and the second window; and
while the first window and the second window are activated, perform a function corresponding to a second user input that is not a touch input based on receiving, in the areas different from the areas of the first window and the second window, the second user input that is not the touch input.

11. A method performed by an electronic device, the method comprising:
displaying a plurality of windows through a display;
setting a first window as an active window by activating the first window among the plurality of windows;
while the first window is activated, setting a touch screen driver to refrain from recognizing a touch input in another area different from an area of the first window;
while the first window is activated, performing a function corresponding to a first user input based on receiving the first user input within the area of the first window; and
while the first window is activated, performing a function corresponding to a second user input that is not a touch input based on receiving, in the another area different from the area of the first window, the second user input that is not the touch input.

12. The method of claim 11, wherein the first window is positioned at the topmost layer among the plurality of windows.

13. The method of claim 11, wherein the first window is set based on a third user input for selecting an active window area among the plurality of windows.

14. The method of claim 11, wherein the second user input includes a pen input received through a digitizer.

15. The method of claim 11, wherein the activating the first window comprises:
identifying the first window among the plurality of windows;
obtaining coordinate information on the area of the first window, the coordinate information including coordinate information of vertices of the first window; and
determining an internal area determined through the coordinate information as an active area.

16. The method of claim 11, further comprising:
setting both the first window and a second window among the plurality of windows as active windows;
while the first window and the second window are activated, setting the touch screen driver to refrain from recognizing a touch input in areas different from areas of the first window and the second window;
while the first window and the second window are activated, performing a function corresponding to the first user input based on receiving the first user input within the areas of the first window and the second window; and
while the first window and the second window are activated, performing a function corresponding to a second user input that is not a touch input based on receiving, in the areas different from the areas of the first window and the second window, the second user input that is not the touch input.

17. The method of claim 11, wherein the first window is set as the active window based on being a most recently used window.

18. The method of claim 11, wherein the touch screen driver includes a setting configured by a filter driver for providing a touch input to an application layer by filtering out the touch input in another area different from an active window area, and
wherein the filter driver is further configured such that, while the first window is activated, based on receiving a touch input in another area different from the area of the first window, the filter driver filters out information on the touch input in the another area different from the area of the first window.

19. A non-transitory computer readable storage medium configured to store instructions that, when executed by at least one processor, cause an electronic device to perform operations including:
displaying a plurality of windows through a display;
setting a first window as an active window by activating the first window among the plurality of windows;
while the first window is activated, setting a touch screen driver to refrain from recognizing a touch input in another area different from an area of the first window;
while the first window is activated, performing a function corresponding to a first user input based on receiving the first user input within the area of the first window; and
while the first window is activated, performing a function corresponding to a second user input that is not a touch input based on receiving, in the another area different from the area of the first window, the second user input that is not the touch input.

20. The non-transitory computer readable storage medium of claim 19, wherein the first window is positioned at the topmost layer among the plurality of windows.
